(19) United States
(12) Patent Application Publication
(10) Pub. No.: US 2010/0191632 A1
(43) Pub. Date: Jul. 29, 2010

(54) VALUATION OF CONTINGENT FINANCIAL CLAIMS USING DECLARATIVE PROGRAMMING TECHNIQUES

(76) Inventors: Apollo HOGAN, Astoria, NY (US); Travis Fisher, Beacon, NY (US); Lipeng Qian, Plainsboro, NJ (US)

Correspondence Address: FROMMER LAWRENCE & HAUG, 745 FIFTH AVENUE- 10TH FL., NEW YORK, NY, 10151, US

(21) Appl. No.: 12/328,512

(22) Filed: Dec. 4, 2008

Related U.S. Application Data
(60) Provisional application No. 60/992,320, filed on Dec. 4, 2007.

(51) Int. Cl. G06Q 40/00

(52) U.S. Cl. 705/35

(57) ABSTRACT

Systems, methods, and computer-readable media are provided relating to computing financial values for contingent claims. A declarative programming language is provided that comprises several primitives. A program according to such a language may combine primitives to create a description of a contingent claim or type of contingent claims. Such a program may be compiled into an executable form and, when executed, may calculate a financial value for a claim. Calculation of the financial value may make use of mathematical models, techniques, or both, including statistical and Monte Carlo methods.

A program may declare one or more parameters to be supplied at execution time, and the computed value may depend on the supplied values of some or all of the parameters.

### CROSS-REFERENCE TO RELATED APPLICATIONS

This application claims the benefit of U.S. Provisional Application No. 60/992,320, titled “VALUATION OF CONTINGENT FINANCIAL CLAIMS USING DERIVATIVE PROGRAMMING TECHNIQUES,” filed on Dec. 4, 2007, which is incorporated herein by reference.

### COPYRIGHT NOTICE

A portion of the disclosure of this patent document contains material that is subject to copyright protection. The copyright owner has no objection to the facsimile reproduction by anyone of the patent document or the patent disclosure as it appears in the Patent and Trademark Office patent files or records, but otherwise reserves all copyrights whatsoever.

This application contains material relating to financial interests. The creation and trading of some financial interests are regulated, as for example by the United States Government, the various state governments, and other governmental agencies within the United States and elsewhere. The disclosure herein is made solely in terms of logical and financial possibility and advantage, without regard to possible statutory, regulatory, or other legal considerations. Nothing herein is intended as a statement or representation of any kind that any method or process proposed or discussed herein does or does not comply with any statute, law, regulation, or other legal requirement whatsoever, in any jurisdiction; nor should it be taken or construed as doing so.

### COMPUTER PROGRAM LISTING APPENDIX

A computer program listing appendix is submitted herewith and is incorporated herein by reference. The appendix contains a single file, named parser.y, which is source code that may be transformed by the well-known program named “bison” into source code for a parser for a computer programming language.

### BACKGROUND

Financial engineering continues to develop new instruments through which market participants may package, buy, and sell financial risk. Many of these instruments involve claims that are in some way contingent, such as, for example, investment contracts in which one or more parties' obligations depend upon parameters such as the price or prices of one or more underlying assets at one or more times. One common type of contingent claim is an option, in which one party grants the other the right to buy or sell, depending on the type of option, a specified asset at a price determined, e.g., by the terms of the contract between the parties, at one or more specified times.

The value of a financial instrument or claim may not be apparent, however. Mathematical techniques have therefore been developed for use in valuing financial claims.

### BRIEF SUMMARY OF THE INVENTION

The invention relates to valuing contingent financial claims. More specifically, embodiments of the invention provide systems and methods for using declarative programming techniques to describe contingent claims. Computer programs according to embodiments of the inventions may then be transformed (e.g., compiled) and executed to estimate the present value of the described contingent claims. Estimation of the value of the claims may in an embodiment of the invention make use of Monte Carlo methods.

Embodiments of the invention provide methods of estimating a financial value of a contingent claim. According to an embodiment of the invention, a method comprises transforming a description of the contingent claim, in terms of a declarative programming language, into a plurality of computer-executable instructions; executing at least some of the instructions to calculate a financial value; and outputting the financial value. According to an embodiment of the invention, the method comprises using Monte Carlo methods to simulate the value of at least one asset that is associated with the contingent claim.

According to some embodiments of the invention, the declarative programming language comprises a plurality of primitives at least including: a primitive signifying a date; a primitive signifying a calendar; a primitive signifying an asset; a primitive signifying a time; and a primitive signifying a payoff. (The word “primitive” is used herein in a broad sense that includes, e.g., the fundamental syntactic or semantic entities related to the context of the discussion.) According to some embodiments of the invention, the declarative programming language may be configured to operate with a description of the contingent claim that comprises a plurality of the primitives. According to an embodiment of the invention, the declarative programming language may be configured to operate with a description of the contingent claim that comprises at least one primitive that signifies an asset, at least one primitive that signifies a stopping time, and at least primitive that signifies a payoff In some embodiments of the invention, transforming the description of the contingent claim comprises mapping each of the at least one primitives that signifies an asset to a respective stochastic process and mapping each of the at least one primitives that signifies a time to a respective stopping time. One result of the transformation in such an embodiment of the invention is mapping the payoff to a stochastic asset stream. In an embodiment of the invention, the calculated financial value is obtained by applying one or more of the Black-Scholes model, the Heston stochastic volatility model, the mixed local-volatility stochastic-volatility model, and the Longstaff-Schwartz technique to estimate the present financial value of the stochastic asset stream.

In some embodiments of the invention, a system is provided for assigning a value to a contingent claim. The system comprises a programmable processor, an interface through which output may be provided, and a memory. Within the memory are stored instructions that, when executed by the processor, cause the system to carry out one or more of the methods, described above, of estimating a financial value of a contingent claim.

In some embodiments of the invention, a computer-readable medium is provided. The medium is encoded with instructions that, when executed by a processor within a computer, cause the computer to carry out one or more of the methods, described above, of estimating a financial value of a contingent claim.

In some embodiments of the invention, a computer-readable medium is provided. The medium is encoded with a computer program that comprises a description of a contingent claim in terms of a declarative programming language. In one embodiment, the programming language comprises a plurality of primitives at least including: a primitive signifying a date; a primitive signifying a calendar; a primitive signifying an asset; a primitive signifying a time; and a primitive signifying a payoff. According to embodiments of the invention, the declarative programming language may be configured to operate with a description of the contingent claim that comprises a plurality of the primitives. According to an embodiment of the invention, the declarative programming language may be configured to operate with a description of the contingent claim that comprises at least one primitive that signifies an asset, at least one primitive that signifies a stopping time, and at least primitive that signifies a payoff. The computer program, when executed by a computer, causes the computer to output a financial value for the contingent claim.

In some embodiments of the invention, a method is provided of configuring a computer system, which comprises at least one processor and at least one memory device operatively coupled to the processor, to process data to estimate the financial values of a plurality of types of contingent claims. The method comprises storing in at least one of the memory devices first instructions that, when executed by a first at least one of the processors, cause the first at least one of the processors to transform a description of a type of contingent claim into second instructions and to store the second instructions in at least one of the memory devices. The method also comprises storing in at least one of the memory devices third instructions that, when executed by a second at least one of the processors, cause the second at least one of the processors to execute the second instructions. In one such embodiment, the description of the type of contingent claims is a program in a declarative programming language, the program declares at least one parameter that is to be supplied at a time when the second instructions are executed, and the second instructions, when executed by a third at least one of the processors, causes the third at least one of the processors to calculate a financial value of a specific contingent claim and to store the financial value in at least one of the memory devices.

In some embodiments of the invention, the declarative programming language of the foregoing method comprises a plurality of primitives. In such an embodiment, a first kind of primitive signifies a date, a second kind of primitive signifies a calendar, a third kind of primitive signifies an asset, a fourth kind of primitive signifies a time, and a fifth kind of primitive signifies a payoff. In one such embodiment, the rules of the declarative programming language requires that any valid description of the contingent claim comprise at least one of the primitives that signifies an asset, at least one of the primitives that signifies a time, and at least one of the primitives that signifies a payoff.

A number of contingent claims, e.g., options, are disclosed in the application. According to some embodiments of the invention, a plurality of the primitives herein are associated with each of a plurality of contingent claims. Thus, the declarative programming language resulting from the transformation of the descriptions of the plurality of contingent claims is applicable to the plurality of contingent claims.

### BRIEF DESCRIPTION OF THE DRAWINGS

The invention is illustrated in the figures of the accompanying drawings, which are meant to be exemplary and not limiting, and in which like references are intended to refer to like or corresponding things.

FIG. 1 is a block diagram depicting a programmable digital computer according to the prior art.

FIG. 2 is a block diagram depicting internetworked computer systems according to the prior art.

FIG. 3 depicts a skeleton of a description of a contingent claim in a declarative programming language according to an embodiment of the invention.

FIGS. 4a and 4b depict descriptions of exemplary contingent claims in a declarative programming language according to an embodiment of the invention.

FIG. 5 is a flow for valuing a contingent claim according to an embodiment of the invention.

FIG. 6 is a flow for transforming a description of a contingent claim into an abstract syntax tree according to an embodiment of the invention.

FIG. 7 is a flow of a simulation that uses Monte Carlo techniques to value a contingent claim according to an embodiment of the invention.

### DETAILED DESCRIPTION OF THE PREFERRED EMBODIMENTS

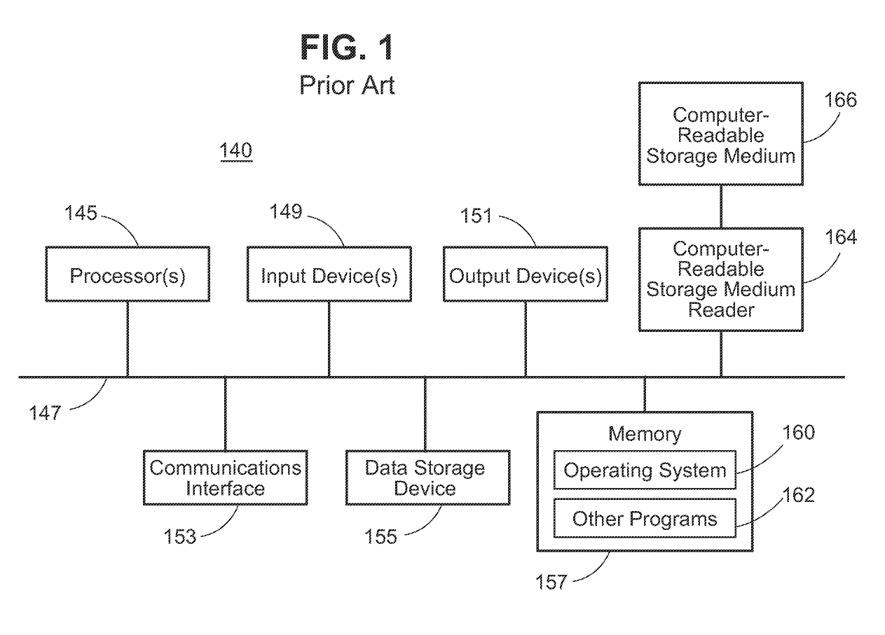

The invention disclosed herein may be practiced using programmable digital computers. FIG. 1 is a block diagram of a representative prior art computer. The computer system 140 includes at least one processor 145, such as, e.g., an Intel Core™2 microprocessor or a Freescale™ PowerPC™microprocessor, coupled to a communications channel 147. The computer system 140 further includes an input device 149 such as, e.g., a keyboard or mouse, an output device 151 such as, e.g., a CRT or LCD display, a communications interface 153, a data storage device 155 such as a magnetic disk or an optical disk, and memory 157 such as Random-Access Memory (RAM), each coupled to the communications channel 147. The communications interface 153 may be coupled to a network (not depicted) such as the Internet.

Although the computer system 140 is shown in FIG. 1 to have only a single communications channel 147, a person skilled in the relevant arts will recognize that a computer system may have multiple channels (not depicted), including for example one or more busses, and that such channels may be interconnected, e.g., by one or more bridges. In such a configuration, components depicted in FIG. 1 as connected by a single channel 147 may interoperate, and may thereby be considered to be coupled to one another, despite being directly connected to different communications channels.

One skilled in the art will recognize that, although the data storage device 155 and memory 157 are depicted as different units, the data storage device 155 and memory 157 can be parts of the same unit or units, and that the functions of one can be shared in whole or in part by the other, e.g., as RAM disks, virtual memory, etc. It will also be appreciated that any particular computer may have multiple components of a given type, e.g., processors 145, input devices 149, communications interfaces 153, etc.

The data storage device 155 and/or memory 157 may store instructions executable by one or more processors 145 or kinds of processors, data, or both. Some groups of instructions, possibly grouped with data, may make up one or more programs, which may include an operating system 160 such as Microsoft Windows XP® or Vista™, Linux®, Mac OS®, or Unix®. Other programs 162 may be stored instead of or in addition to the operating system. It will be appreciated that a computer system may also be implemented on platforms and operating systems other than those mentioned. Any operating system 160 or other program 162, or any part of either, may be written using one or more programming languages such as, e.g., Java®, C, C++, C#, Visual Basic®, VB.NET®, Perl, Ruby, Python, or other programming languages, possibly using object oriented design and/or coding techniques.

One skilled in the art will recognize that the computer system 140 may also include additional components and/or systems, such as network connections, additional memory, additional processors, network interfaces, input/output busses, for example. One skilled in the art will also recognize that the programs and data may be received by and stored in the system in alternative ways. For example, a computer-readable storage medium (CRSM) reader 164, such as, e.g., a magnetic disk drive, magneto-optical drive, optical disk drive, or flash drive, may be coupled to the communications bus 147 for reading from a computer-readable storage medium (CRSM) 166 such as, e.g., a magnetic disk, a magneto-optical disk, an optical disk, or flash RAM. Alternatively, one or more CRSM readers may be coupled to the rest of the computer system 140, e.g., through a network interface (not depicted) or a communications interface 153. In any such configuration, however, the computer system 140 may receive programs and/or data via the CRSM reader 164. Further, it will be appreciated that the term “memory” herein is intended to include various types of suitable data storage media, whether permanent or temporary, including among other things the data storage device 155, the memory 157, and the CSRM 166.

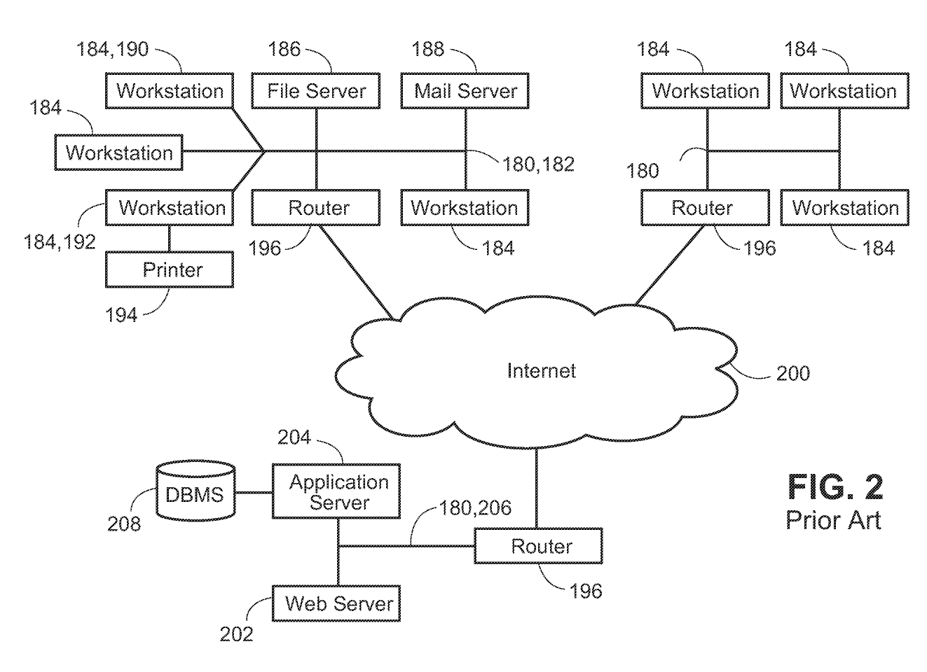

Two or more computer systems 140 may be connected, e.g., in one or more networks, via, e.g., their respective communications interfaces 155 and/or network interfaces (not depicted). FIG. 2 is a block diagram of representative prior art interconnected networks 180, such as may be useful in connection with embodiments of the invention.

A network 182 may, for example, connect one or more workstations 184 with each other and with other computer systems, such as file servers 186 or mail servers 188. The connection may be achieved tangibly, e.g., via Ethernet® or optical cables, or wirelessly, e.g., through use of modulated microwave signals according to the IEEE 802.11 family of standards. A computer system that participates in the network may send data to another computer system in the network via the network connection.

One use of a network 180 is to enable a computer system to provide services to other computer systems, consume services provided by other computer systems, or both. For example, a file server 186 may provide common storage of files for one or more of the workstations 190 on a network 182. A workstation 190 sends data including a request for a file to the file server 186 via the network 182 and the file server 186 may respond by sending the data from the file back to the requesting workstation 190.

As will be recognized by those skilled in the relevant art, the terms “workstation,” “client,” and “server” are used herein to describe a computer's function in a particular context. A workstation may, for example, be a computer that one or more users work with directly, e.g., through a keyboard and monitor directly coupled to the computer system. A computer system that requests a service through a network is often referred to as a client, and a computer system that provides a service is often referred to as a server. But any particular workstation may be indistinguishable in its hardware, configuration, operating system, and/or other software from a client, server, or both.

Further, a computer system may simultaneously act as a workstation, a server, and/or a client. For example, as depicted in FIG. 2, a workstation 192 is connected to a printer 194. That workstation 192 may allow users of other workstations on the network 182 to use the printer 194, thereby acting as a print server. At the same time, however, a user may be working at the workstation 192 on a document that is stored on the file server 186.

A network 182 may be connected to one or more other networks 180, e.g., via a router 196. A router 196 may also act as a firewall, monitoring and/or restricting the flow of data to and/or from a network 180 as configured to protect the network. A firewall may alternatively be a separate device (not pictured) from the router 196.

A network of networks 180 may be referred to as an internet. The term “the Internet” 200 refers to the worldwide network of interconnected, packet-switched data networks that uses the Internet Protocol (IP) to route and transfer data. A client and server on different networks may communicate via the Internet 200. For example, a workstation 190 may request a World Wide Web document from a Web Server 202. The Web Server 202 may process the request and pass it to, e.g., an Application Server 204. The Application Server 204 may then conduct further processing, which may include, for example, sending data to and/or receiving data from one or more other data sources. Such a data source may include, e.g., other servers on the same network 206 or a different one and/or a Database Management System (“DBMS”) 208.

Computer programs most commonly are created and modified using one or more programming languages. A programming language is an artificial language capable of expressing a desired computation. A computer program is commonly created using one or more text editors, graphical tools, or both.

Different programming languages may reflect different paradigms for expressing computation. Imperative programming languages, such as C, Pascal, and FORTRAN, require expression of a program as a series of instructions that change a computational state. This state may involve, for example, inputs, outputs, and the content (including interrelationships) of data in a computer memory.

Object-oriented programming couples data structures, which are regarded as objects, with operations on the data structures. Most object-oriented programming languages use an imperative style to express the operations, although some do not. Object-oriented programming techniques have become very popular, and common or influential object-oriented programming languages include, e.g., Smalltalk, C++, and Java.

Functional programming treats a program as a collection of mathematical functions, eschewing any outright reference to computational state. Most functional programming languages have been influenced by the lambda calculus developed by Alonzo Church, although few such languages limit themselves to purely functional constructs. Despite some prominent practical and commercial use, functional programming has been predominantly of academic use. The best-known functional programming languages are the LISP family of languages, particularly the Scheme and Common LISP dialects.

Declarative programming techniques, such as used by embodiments of the invention, involve describing the desired result of the computation. This is in contrast to imperative, object-oriented, and functional programming, described above, which involve describing the computational process. One example of a declarative language is SQL, in which an expression describes the data that is to be retrieved from a database but does not specify how that data is to be retrieved. Another example is XSLT, which specifies transformations that are to be made in an XML document without designating algorithms for identifying or making the translations.

In an embodiment of the invention, a declarative programming language supplies a collection of primitives which may be combined to create a description of one or more contingent claims. A contingent claim, in connection with embodiments of this invention, may involve one or more transactions. A transaction, in turn, may involve receiving or paying a certain amount of an asset (which may be cash, denominated in a certain currency).

A contingent claim in connection with an embodiment of the invention may involve one or more transactions, any one or more of which may be associated with one or more conditions, contingencies, or both. A partial list of such conditions and contingencies may include, for example: (a) doing one or more transactions at a certain time or series of times; (b) doing one or more transactions upon the occurrence of one or more events; (c) at a certain time, one or more parties has the option to do one or more transactions or not; (d) at a certain time, one or more parties has the power to choose one or more of a plurality of alternative transactions; and (e) upon the occurrence of one or more events, one or more parties has the option to do one or more transactions or not. Other conditions, contingencies, or both, may relate to the price at which one or more transactions may or will occur. It will be appreciated by one skilled in the art that many other conditions and contingencies, in addition to or instead of some or all of the foregoing, may apply to any one or more transactions to create a contingent claim.

It will further be appreciated that contingent claims may be created involving practically any imaginable combination of conditions, contingencies, or both. Reflecting the possibility of such combination, a declarative programming language according to an embodiment of the invention may include constructs allowing synthesis and/or combination of transactions, conditions, and/or contingencies based on one or more primitives.

A simple example of a contingent claim, such as may be described in a declaratory programming language according to an embodiment of the invention, is a European-style call option, denominated in U.S. dollars. This option gives the holder the right, but not the obligation, to purchase a specified quantity of euros for a specified amount of dollars on a specified date (sometimes called the “expiration date”). The present value of this claim may be expected to depend on the expected spot exchange rate on the expiration date.

A more complicated claim may have several contingencies based upon the spot price of an underlying asset. For example, one claim may pay one million dollars in one year unless, during the one-year period, the spot price of the underlying asset crosses below a specified level L and then crosses above level L_{H} or below level L_{L}, or (2) the spot price crosses above the level H and then crosses above level H_{H} or below level H_{L}. The present value of such a claim may not be expected to depend directly on the expected spot price of the underlying asset in a year, but rather on the expected volatility of that price during the year.

Despite the use of the term “contingent claim” herein to describe assets that may be described and evaluated, a declarative programming language according to an embodiment of the invention may be capable of describing an asset that does not actually depend on any contingencies. For example, a language may accept a description of a cash payment to be received, unconditionally, one year from the present date and that description may be used in an embodiment of the invention to calculate the present value of the payment. Use of the term “contingent claim” reflects only an expectation that that embodiments of the invention are used most often in connection with claims that depend upon one or more contingencies, but the invention is not in any way limited to such contingent claims.

A common practice in the relevant arts is to use Greek letters to denote certain quantities related to derivative securities, including some contingent claims. These quantities may therefore commonly be referred to as “the Greeks.” Because of this common use of “the Greeks,” the meaning of the term is sometimes expanded to include certain quantities with names that are not Greek letters. Table 1 lists several of the Greeks such as may be meaningful in connection with an embodiment of the invention.

TABLE 1

| Quantity | | |
|---|---|---|
| Name | Description | Formula |
| delta (Δ) | The first derivative of the value, V, of a derivative security or portfolio of derivative securities with respect to the price, S, of one of the underlying assets. | $Δ = \frac{\partial V}{\partial S}$ |
| gamma (Γ) | The second derivative of the value, V, of a derivative security or portfolio of derivative securities with respect to the price, S, of one of the underlying assets. The first derivative of Δ with respect to S. | $Γ = \frac{{\partial }^{2} V}{{\partial }^{2} S}$ |
| theta (Θ) | The negative of the first derivative of the value, V, of a derivative security or portfolio of derivative securities with respect to time, T. | $Θ = - \frac{\partial V}{\partial T}$ |
| rho (ρ) | The first derivative of the value, V, of a derivative security or portfolio of derivative securities with respect to the risk-free interest rate, r. | $ρ = \frac{\partial V}{\partial r}$ |
| vega (not a Greek letter; “ν” or nu is used to represent it) | The first derivative of the value, V, of a derivative security or portfolio of derivative securities with respect to one of the volatilities, σ, corresponding to one of the underlying assets. | $ν = \frac{\partial V}{\partial σ}$ |
| lambda (λ) | The relative change in the value, V, of a derivative security with respect to a change in the price, S, of one of the underlying assets. | $λ = \frac{\partial V}{\partial S} \times \frac{1}{V}$ |

According to one embodiment of the invention, a declarative programming language suited to valuing contingent claims includes primitives to describe assets, calendars, times, processes, baskets, values, transactions and payoffs. The primitives may then be combined according to the rules of the declarative programming language to describe a contingent claim to be valued. A collection of primitives according to an embodiment of the invention is described in more detail below, as are the syntax and semantics of a declarative programming language according to an embodiment of the invention.

In describing herein the parameters supplied to some of the primitives according to an embodiment of the invention, a notation similar to xxx::yyy is used. Where such a notation appears, the symbol to the left of the two adjacent colons designates the parameter, and the symbol to the right of the two adjacent colons designates the type of the parameter. That type may indicate a type of primitive (e.g., “cal” for a calendar primitive or “process” for a process primitive) or a designation of a set of possible values (e.g., [symbol] for the set of natural numbers or [symbol] for the set of real numbers). Such notation, as such, may not necessarily be meaningful or legal in a declarative programming language according to any embodiment of the invention. This notation is used solely for the sake of clarity herein in describing certain exemplary embodiments of the invention, and is not meant to express or imply any limits to the scope of the invention.

“Asset” is used in a broad sense to refer to anything that may be owned that has commercial or exchange value. According to an embodiment of the invention, a primitive that represents an asset is an opaque symbol that, in some context connected with that embodiment, may be recognized as designating that particular asset. Examples of possible asset primitives according to an embodiment of the invention include stock ticker symbols (e.g., “T,” which represents the common stock of AT&T, Inc., and “IBM,” which represents the common stock of International Business Machines Corp.), currency symbols (e.g., “USD” for U.S. dollars and “EUR” for euros), and names of commodities or other symbols chosen to represent them (e.g., “GOLDS” for gold bullion and “COA” for the benchmark classification of crude oil), to name only a very few of a great many possibilities.

A calendar, according to an embodiment of the invention, is an ordered set of dates that are considered significant to the valuation of one or more contingent claims. Examples of calendars according to such an embodiment may include, for example, all the days of a given year, all the days of a given month, all days in a given quarter in which stock markets in a particular location are open for trading, and all standardized option expiration dates in a given three-year period. The dates in a calendar according to an embodiment need not be selected according to any particular rule, however; in an embodiment of the invention, any specified collection of dates, even arbitrary ones, may make up a calendar, such as, for example, a collection consisting of the second, fifth, forty-third, and eighty-eighth days following a given day.

In an embodiment of the invention, the contents of all calendars are declared as parameters in a program, describing a contingent claim, in a declarative programming language. In such an embodiment, one or more specific values may be supplied when the program is executed, as described more particularly below.

According to an alternative embodiment of the invention, a declarative programming language may define one or more standard calendars that may be included in a program. In such an embodiment, one or more of the standard calendars may accept one or more parameters at execution time to define, e.g., starting and/or ending dates. Depending on the embodiment of the invention, the one or more such standard calendars may be provided instead of or in addition to the fully specified calendars described above.

In an embodiment of the invention, on or more other primitives take one or more calendars as parameters. In describing such primitives herein in connection with exemplary embodiments of the invention, a common notation is used, although such notation, as such, may not necessarily be meaningful or legal in a declarative programming language according to any embodiment of the invention. This notation is used solely for the sake of clarity herein in describing certain exemplary embodiments of the invention, and is not meant to express or imply any limits to the scope of the invention.

According to this notation, given a calendar c and dates s and t, the expression c[s, t] designates all dates in the calendar that are on or after s, but on or before t. The expression c[≦t] designates all dates in the calendar that are on or before t. The expression t⊖_{c}n designates the nth date in the calendar c before date t. The expression t⊖_{c}n designates the nth date in the calendar c after time t.

In connection with an embodiment of the invention, it may be meaningful to use some or all of the above expressions when calendar c does not comprise s and/or t. For example, in connection with one such embodiment of the invention, if calendar c does not comprise the date t, then t⊖_{c}0 designates the date in c that most closely precedes t, and t⊕_{c}0 designates the date in c that most closely follows t. In connection with that embodiment, however, if c does comprise t, then both t⊖_{c}0 and t⊕D_{c}0 designate the same date in c, which is t.

In an embodiment of the invention, a primitive designating a time indicates when an event occurs. In an embodiment of the invention, a time primitive may designate, e.g., a fixed date, a date relative to another date, or a random date, e.g., the first crossing of a barrier by a specified spot price. Table 2 indicates a collection of time primitives according to an exemplary embodiment of the invention.

TABLE 2

| Primitive | Meaning |
|---|---|
| FIXED(n:: [symbol] ) | A fixed date |
| FIXED_TIME(n:: [symbol] ) | A fixed date |
| AFTER(c::cal, n:: [symbol] , t::time) | n c-points (i.e., dates according to calendar c) |
| | after t |
| BEFORE(c::cal, n:: [symbol] , t::time) | n c-points before t |
| FIRST(t₁::time, ... , tₙ::time) | The first of t₁, ... , tₙ to occur |
| LAST(t₁::time, ... , tₙ::time) | The last of t₁, ... , tₙ to occur |
| TRUNCATE(t::time, x::time) | t, if it occurs before x; positive infinity |
| | otherwise |
| NOT_UNTIL(t::time, x::time) | t, if it occurs after x; positive infinity otherwise |
| HIT_UP(c::cal, t::time, P::process, H:: [symbol] ) | First time after t (according to calendar c) at |
| | which the value of P is greater than or equal to |
| | H |
| HIT_DOWN(c::cal, t::time, P::process, H:: [symbol] ) | First time after t (according to calendar c) at |
| | which the value of P is less than or equal to H |
| INDICATOR(c::cal, t::time, P::process) | First time after t (according to calendar c) at |
| | which P is “triggered,” i.e., the value of P is |
| | not equal to zero. |

In an embodiment of the invention, primitives are provided that represent processes, and these primitives may generate a time series of values. Depending on the process, the generated values may be deterministic or random or pseudo-random. Table 3 indicates a collection of primitives related to processes according to an exemplary embodiment of the invention.

TABLE 3

| Primitive | Meaning |
|---|---|
| SPOT(A::asset, B::asset) | Daily fixing of the spot price for asset A in |
| | terms of asset B, generated by a (possibly |
| | random or pseudo-random) model. For |
| | example, SPOT (EUR, USD) refers to the spot |
| | price of euro in U.S. dollars. |
| SPOT_INTRADAY_MAX(A::asset, B::asset) | Intraday maximum of the spot price for asset A |
| | in terms of asset B, generated by a (possibly |
| | random or pseudo-random) model. |
| SPOT_INTRADAY_MIN(A::asset, B::asset) | Intraday minimum of the spot price for asset A |
| | in terms of asset B, generated by a (possibly |
| | random or pseudo-random) model. |
| SPOT_INTRADAY_AVE(A::asset, B::asset) | Intraday (continuous) average of the spot price |
| | for asset A in terms of asset B, generated by a |
| | (possibly random or pseudo-random) model. |
| SPOT_INTRADAY_HIT_UP(A::asset, B::asset, H:: [symbol] ) | Indicator of intraday breaching of up-barrier, |
| | generated by a (possibly random or pseudo- |
| | random) model. |
| SPOT_INTRADAY_HIT_DOWN(A::asset, B::asset, | Indicator of intraday breaching of down-barrier, |
| H:: [symbol] ) | generated by a (possibly random or pseudo- |
| | random) model. |
| SPOT_INTRADAY_HIT_UP_DOWN(A::asset, | Indicator of intraday breaching of both up- |
| B::asset, H:: [symbol] ) | barrier and down-barrier, generated by a |
| | (possibly random or pseudo-random) model. |
| INDICATOR(OP, P::process, H:: [symbol] ), where OP designates an operator and OP ∈ {>=, <=, >, <} | $V ( t ) = \{ \begin{matrix}1 if P ( t ) OPH \\ 0 otherwise\end{matrix}$ |
| RUNNING_MAX(c::cal, P::process) | $V ( t ) = {max}_{s ∈ c [ \leq t ]} P ( s )$ |
| RUNNING_MIN(c::cal, P::process) | $V ( t ) = {min}_{s ∈ c [ \leq t ]} P ( s )$ |
| RUNNING_SUM(c::cal, P::process) | $V ( t ) = {\sum }_{s ∈ c [ \leq t ]} P ( s )$ |
| RUNNING_AVE_ARITH(c::cal, P::process) | $\begin{matrix}V ( t ) = \frac{1}{\# c [ \text{≤} t ]} {\sum }_{s ∈ c [ \leq t ]} P ( s ) , \\ where \# c [ \text{≤} t ] desinates the number of dates \\ in calendar c up to and including time t .\end{matrix}$ |
| RUNNING_AVE_GEOM(c::cal, P::process) | $\begin{matrix}V ( t ) = {( {\prod }_{s ∈ c [ \leq t ]} P ( s ) )}^{\frac{1}{\# c [ \leq t ]}} , \\ where \# c [ \text{≤} t ] desinates the number of dates \\ in calendar c up to and including time t .\end{matrix}$ |
| ROLLING_MAX(c::cal, n:: [symbol] , P::process) | $V ( t ) = {max}_{s ∈ c [ t {⊖}_{c} ( n - 1 ) , t ]}$ |
| ROLLING_MIN(c::cal, n:: [symbol] , P::process) | $V ( t ) = {min}_{s ∈ c [ t {⊖}_{c} ( n - 1 ) , t ]}$ |
| ROLLING_SUM(c::cal, n:: [symbol] , P::process) | $V ( t ) = {\sum }_{s ∈ c [ t {⊖}_{c} ( n - 1 ) , t ]} P ( s )$ |
| ROLLING_AVG_ARITH(c::cal, n:: [symbol] , P::process) | $V ( t ) = ( \frac{1}{n} ) {\sum }_{s ∈ c [ t {⊖}_{c} ( n - 1 ) , t ]} P ( s )$ |
| ROLLING_AVG_GEOM(c::cal, n:: [symbol] , P::process) | $V ( t ) = {( {\prod }_{s ∈ c [ t {⊖}_{c} ( n - 1 ) , t ]} P ( s ) )}^{\frac{1}{n}}$ |
| INDEX(a₁:: [symbol] , P₁::process, . . . , aₙ:: [symbol] , Pₙ::process) | $V ( t ) = {\sum }_{i = 1}^{n} {a}_{i} {P}_{i} ( t )$ |
| MAX_OF(P₁::process, . . . , Pₙ::process) | $V ( t ) = {max}_{i = 1}^{n} {P}_{i} ( t )$ |
| MIN_OF(P₁::process, . . . , Pₙ::process) | $V ( t ) = {min}_{i = 1}^{n} {P}_{i} ( t )$ |
| ARMA(c::cal, b:: [symbol] , P::process, a₁:: [symbol] , . . . , aₙ:: [symbol] ) | $V ( t ) = bP ( t {⊖}_{c} 0 ) + {\sum }_{i = 1}^{k} {a}_{i} V ( t {⊖}_{c} i )$ |
| NTH_BEST(n:: [symbol] , P₁::process, . . . , Pₙ::process) | V(t) = P_{π(n)}(t), |
| | where π ∈ S^{k} such that |
| | P_{π(1)}(t) ≧ P_{π(2)}(t) ≧ . . . ≧ P_{π(k)}(t) |
| NTH_WORST(n:: [symbol] , P₁::process, . . . , Pₙ::process) | V(t) = P_{π(k+1-n)}(t), |
| | where π ∈ S^{k} such that |
| | P_{π(1)}(t) ≧ P_{π(2)}(t) ≧ . . . ≧ P_{π(k)}(t) |
| RETURN(c::cal, P::process) | $V ( t ) = \frac{P ( t ) - P ( t {⊖}_{c} 0 )}{P ( t {⊖}_{c} 0 )}$ |
| LAGGED(c::cal, P::process, n:: [symbol] ) | V(t) = P(t⊖_{c}n) |
| FORMULA_OF(P::process, f:: [symbol] → [symbol] ) | V(t) = f(P(t)) |

In an embodiment of the invention, one or more primitives may be defined that represent “baskets.” A basket, in this sense, provides indexes (which may reflect a ranking) for processes within a set. Table 4 indicates a collection of primitives related to baskets according to an exemplary embodiment of the invention.

TABLE 4

| Primitive | | Description |
|---|---|---|
| BASKET_RANKED_BY_VALUE(c::cal, | | V{i}(t) = P_{π(i)}(t), where π ε Sⁿ such that |
| | P₁::process, ... , Pₙ::process) | P_{π(1)}(t⊖_{c}0) ≧...≧ P_{π(n)}(t⊖_{c}0). |
| | | The basket elements P₁,...,Pₙ are re-sorted at |
| | | each calendar date according to their value. |
| BASKET_RANKED_BY_PROCESS(c::cal, | | V{i}(t) = P_{π(i)}(t), where π ε Sⁿ such that |
| | P₁::process, ... , Pₙ::process, | R_{π(1)}(t⊖_{c}0) ≧...≧ P_{π(n)}(t⊖_{c}0) |
| | R₁::process, ... , Rₙ::process) | The basket elements P₁,...,Pₙ are re-sorted at |

each calendar date according to the values of
auxiliary processes R₁,...,Rₙ.

A value in connection with an embodiment of the invention is a single number. In a declarative program according to an embodiment of the invention, a value is given by an expression. In an embodiment of the invention, expressions may include, for example: literals (sometimes referred to as “constants”), such as “1.3”; process values (specified in connection with a time), such as “S[T]”; arithmetic operators, such as “+”, “−”, “*”, and “/”; mathematical functions (e.g., “MIN”, “MAX”, and “SQRT”); and Boolean operators, such as “>”, “>=”, “<”, “<=”, “==”, and “˜=”. A declarative programming language according to an embodiment of the invention may include other operators and/or other kinds of operators in addition to and/or instead of some or all of those listed here.

According to an embodiment of the invention, a transaction is a value, with an associated asset, that denotes the transfer of a specified amount of that asset. In a declarative programming language according to an embodiment of the invention, a transaction may be indicated by a construct of the form VALUE′ASSET. For example, a transaction involving the value of the process S, at time T, where the value indicates a number of U.S. dollars, may be indicated by the construct “S[T]′USD”. According to an embodiment of the invention, transactions may be added to and/or subtracted from other transactions, possibly representing, e.g., receiving one or more assets in exchange for payment of one or more other assets.

In an embodiment of the invention, primitives may be provided that correspond to payoffs and operations that combine and/or select one or more payoffs from a specified set. Payoffs may be considered the elements of a declarative programming language, in accordance with some embodiments of the invention, that describe the contingent claims, at least by providing the elements that indicate contingencies. Payoff primitives according to an exemplary embodiment of the invention are collected in Table 5.

TABLE 5

| Primitive | Meaning |
|---|---|
| AT(t::time, v::transaction) | Pays out the transaction v at time t. |
| | In an embodiment of the invention, this |
| | primitive may account for some or all factors |
| | that may affect the value of the transaction |
| | between a beginning date and time t. In an |
| | embodiment of the invention, one or more of |
| | any such factors may be accounted for, if at all, |
| | only as they are explicitly included in the |
| | description of the payoff. |
| FIRST_BORN(P₁::payoff, ... , Pₙ::payoff) | Gives the first payoff to become active, |
| | discarding the others. |
| FIRST_DEAD(P₁::payoff, ... , Pₙ::payoff) | As payoffs become active, they are held (with |
| | benefits, costs, etc. accruing) until one of the |
| | payoffs end; at that time, all payoffs cease. |
| LAST_BORN(P₁::payoff, ... , Pₙ::payoff) | Gives the first payoff to become active, then, |
| | as each subsequent payoff becomes active, |
| | gives the newly-activated payoff and discards |
| | the previous one. |
| LAST_DEAD(P₁::payoff, ... , Pₙ::payoff) | The last payoff to survive is acquired at the |
| | time all other payoffs cease. |
| CHOOSE(t::time, P₁::payoff, ... ,Pₙ::payoff) | At time t, the holder chooses between payoffs |
| | and acquires that payoff. |
| SHORT_CHOOSE(t::time, P₁::payoff, ... , Pₙ::payoff) | At time t, someone other than the holder |
| | chooses between payoffs and the holder |
| | acquires that payoff. |
| ACQUIRE(t::time, P₁::payoff, ... , Pₙ::payoff) | At time t, the holder acquires each payoff. |
| LOSE(t::time, P₁::payoff, ... , Pₙ::payoff) | Equal to a portfolio of payoffs that the holder |
| | loses at time t. |
| PERIODIC_ACQUIRE(c::cal, t_{b}::time, tₑ::time, | At each time s ∈ c such that t_{b} ≦ s ≦ tₑ, the |
| π::time → payoff) | holder acquires the payoff π(s). |
| PERIODIC_CHOOSE(c::cal, t_{b}::time, tₑ::time, | The holder periodically has the option to |
| π_{b}::time → payoff, ... , πₑ::time → payoff) | commit to one of a choice of payoffs. |
| PERIODIC_SHORT_CHOOSE(c::cal, t_{b}::time, tₑ::time, | Someone other than the holder may |
| π_{b}::time → payoff, ... , πₑ::time → payoff) | periodically choose to commit the holder to |
| | one of a choice of payoffs. |
| OPTIONALLY(t::time, P₁::payoff) | At time t, the holder chooses between |
| | acquiring a payoff and taking nothing. |
| | This is equivalent to CHOOSE(t, P, AT(t, 0)), and |
| | therefore may in some cases be considered not |
| | to be a primitive. |
| OPTIONALLY_AT(t::time, T::transaction) | Equivalent to OPTIONALLY(t, AT(t, T)), and |
| | therefore may in some cases be considered not |
| | to be a primitive. |

According to an embodiment of the invention, a declarative programming language may specify syntactic rules for combining primitives, such as those described above, into permissible descriptions of contingent claims. Such a description may then be transformed and/or executed, e.g., as described below, to estimate a value for the contingent claim.

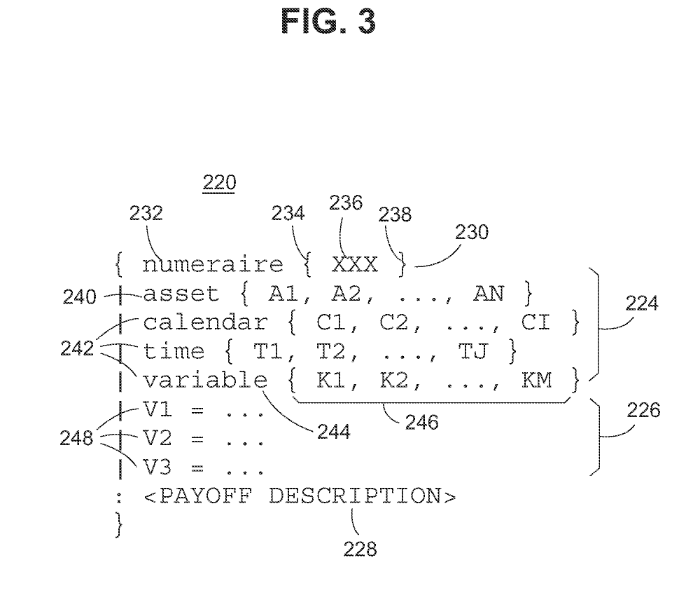

FIG. 3 depicts a skeleton 220 of a permissible description (which may be considered a program) of a contingent claim according to one embodiment of the invention. The skeleton according to the depicted embodiment of the invention has three parts: a preamble 224, a declarations section 226 (which may include declaration and/or definition of one or more additional processes used to calculate the value of the contingent claim), and a payoff description 228. As depicted, the program begins with a left curly bracket (“{”) and ends with a right curly bracket (“}”).

As FIG. 3 depicts, the preamble 224 in an embodiment of the invention comprises a declaration of the numeraire 230, which indicates the currency in which the value of the contingent claim is to be calculated. The declaration of the numeraire 230 according to the depicted embodiment of the invention begins with the literal token “numeraire” 232, followed by a left curly bracket 234, a symbol indicating the value of the numeraire 236, followed by a right curly bracket 238. In an embodiment of the invention, the symbols that indicate the numeraire are the three-letter codes commonly used within financial markets to denote currencies. For example, “USD” may indicate U.S. dollars, while “JPY” may indicate Japanese yen.

The declaration of the numeraire 230 in the depicted embodiment of the invention is followed by a vertical line 240 (“|”) to separate the declaration 230 from the rest of the preamble 224.

The remainder of the preamble 224 declares parameters 242 to the program, which may in an embodiment of the invention be supplied when the program is executed. Each parameter declaration 242 begins with the name of the type 244 of parameter being declared, e.g., “asset” or “calendar”. The name is followed by a list of parameters 246, separated by commas and enclosed in curly brackets. In the depicted embodiment of the invention, a vertical line appears between each of the parameter declarations 242, and another vertical line follows the final parameter declaration, separating the preamble 224 from the remainder of the program 220.

According to an embodiment of the invention, the parameters, once declared, may be referred to by portions of the program that follow the declaration.

In the embodiment of the invention depicted in FIG. 3, the preamble 224 is optionally followed by one or more definitions 248 of specific times and/or processes used to compute the payoff. A definition 248 may in an embodiment of the invention involve assigning a symbolic name (e.g., “V1”) to an expression that composes two or more primitives to define a new time or process. In an embodiment of the invention, the defined time or process may then be referred to by its symbolic name in the description of the payoff 228. In the depicted embodiment of the invention, the definitions 248 are delimited by white space, and a colon separates the definitions 226 from the payoff description 228.

In the depicted embodiment of the invention, the payoff description 228 comprises a single payoff or an expression combining two or more payoffs that in some way describes a composite payoff.

Depending upon the embodiment of the invention, whitespace within the program may or may not be significant except as needed to delimit tokens in the program. Additionally, depending upon the embodiment of the invention, capitalization of some or all letters in some or all elements of a program may or may not be significant. For example, “spot intraday max” and “SPOT_INTRADAY_MAX” may be considered to refer to the same thing according to one embodiment of the invention but may be considered to refer to different things according to another embodiment.

A specification of the syntax of a declarative programming language according to an embodiment of the invention is in the source code appendix hereto. The appendix contains a single file, which may be used as a source file by the Unix® tool YACC (or the GNU equivalent, bison) to automatically generate a parser capable of recognizing valid programs according to a declarative programming language in an embodiment of the invention. It will be appreciated by those having skill in the relevant arts that such a source file is a precise specification of the syntax of a programming language.

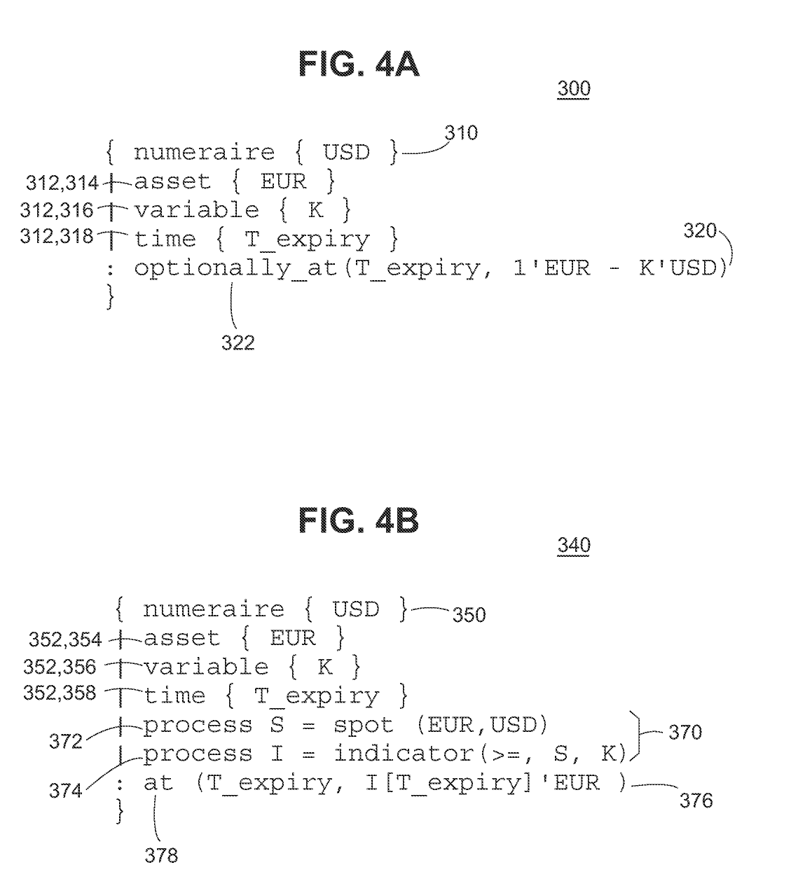

FIG. 4a depicts an example of a entire program 300 in a declarative programming language according to an embodiment of the invention. The program 300 describes a common, relatively simple contingent claim, which may commonly be known as a “European-style call option.” The option, priced in U.S. dollars, gives the holder the right, but not the obligation, to buy 1 euro at a specified price in U.S. dollars (the “strike price”), on a specified date (the “expiration date”). The option may be exercised, if at all, only on the expiration date; after that date, the contract is worthless.

In practice, a call option such as described might give the holder the right to buy thousands, or even hundreds of thousands, of euro at the specified exchange rate, but it will be appreciated that the value of such a contract may be obtained by calculating the value of such a contract for a single euro and then multiplying that value by the number of euro covered by the contract.

The numeraire section 310 declares that the value is to be calculated in U.S. dollars. The parameter declarations 312 include a declaration of a single asset (“EUR”) 314, a single variable (“K”) 316, and a single time (“T_expiry”) 318. According to an embodiment of the invention, the values of these parameters will be supplied at the time the program is executed.

The payoff description 320 includes a single primitive, “optionally_at” 322. Referring to Table 5, above, it can be seen that this primitive takes two parameters: a time and a transaction. As depicted in FIG. 4a, the time is “T_expiry”, which may correspond to the expiration date of the option. The transaction is “1′EUR-K′USD”, which may indicate receiving 1 euro in exchange for K dollars. Referring again to Table 5, it may be seen that the meaning of this payoff is that the holder of the option has the choice at time T_expiry of receiving the value at time T_expiry of 1 euro in exchange for K dollars.

FIG. 4b depicts a second complete program 340 in a declarative programming language according to an embodiment of the invention. The program 340 describes a contingent claim, priced in U.S. dollars, that pays a fixed amount of dollars at the expiration date if the euro/dollar exchange rate is at or above a specified strike, but pays nothing if the exchange rate is below the strike price on the expiration date. Such a claim may commonly be referred to as a “cash-or-nothing digital call” or a “cash-or-nothing binary call.”

The numeraire section 350 of the program 340 declares that the value is to be calculated in U.S. dollars. The parameter declarations 352 include a declaration of a single asset (“EUR”) 354, a single variable (“K”) 356, and a single time (“T_expiry”) 358. According to an embodiment of the invention, the values of these parameters will be supplied at the time the program is executed.

The definitions section 370 of the depicted program 340 includes two definitions. The first 372 assigns the symbol “S” to the process SPOT(EUR, USD), which, according to an embodiment of the invention as described previously, provides values for the spot exchange rate at various times. The second definition 374 assigns the symbol “I” to the process INDICATOR(>=, S, K). This definition 374 relies on the first definition 372, which defined S. According to an embodiment of the invention as described previously, this process returns the numeric value 1 at any time when the value of the process S is greater than or equal to the value of the parameter K, and 0 at all other times.

The payoff description 376 includes a single primitive, which is “at” 378. Referring to Table 5, above, it can be seen that in an embodiment of the invention, this primitive takes two parameters: a time and a transaction. The time in the depicted program 340 is “T_expiry”, which may correspond to the expiration date of the option. The transaction is “I[T_expiry]′USD”, which in an embodiment of the invention designates a number of U.S. dollars equal to the numeric value of the process I at the time T_expiry.

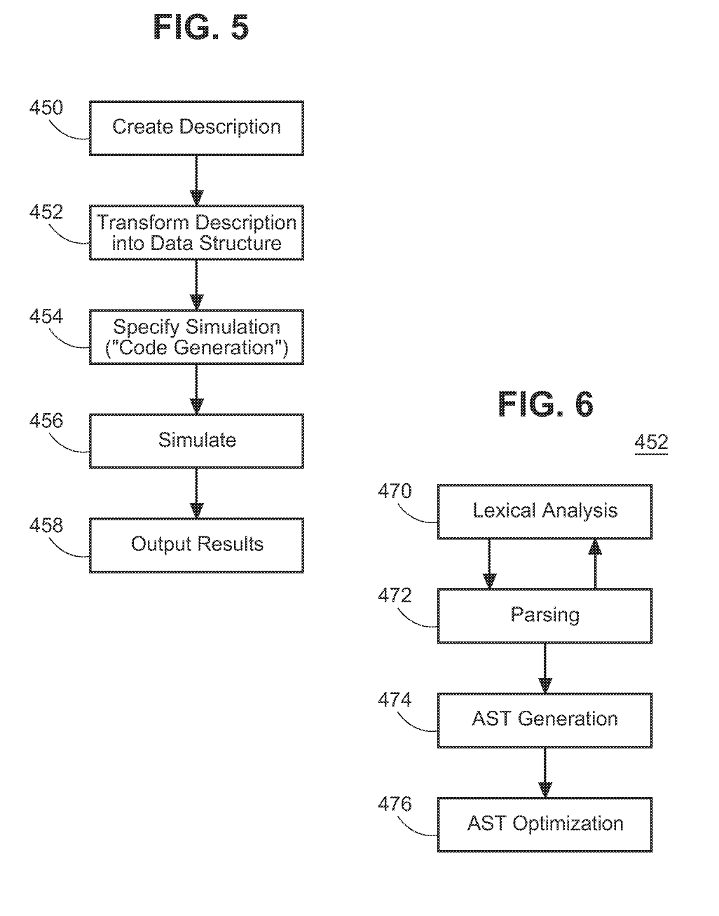

FIG. 5 is an overview of an exemplary workflow that includes using a description in a declarative programming language to value a contingent claim according to an embodiment of the invention. In block 450, a description of a contingent claim is created, e.g., by a programmer or analyst, in terms of a declarative programming language according to an embodiment of the invention. In block 452, a data structure is created that represents the description. In block 454, the data structure is used to specify a simulation that will calculate a value for the contingent claim. The simulation itself takes place in block 456, and the results of the simulation are provided in block 458.

FIG. 6 depicts in greater detail creation of the data structure represented by block 452 in FIG. 5. Block 470 in FIG. 6 represents identification by a computer program or part of a program (commonly referred to as a “lexical analyzer”) of the syntactic elements (often referred to as “lexemes”) that make up the description, according to an embodiment of the invention. In block 472, the lexemes are processed by a computer program or part of a program (commonly referred to as a “parser”) to create a data structure representing the description as a whole. Depending on the embodiment of the invention, lexical analysis 470 and parsing 472 may be distinct, or the lexical analyzer (also sometimes referred to as a “scanner”) and the parser may interact; e.g., the scanner may identify the next lexeme in the input in response to an indication by the parser that it has finished processing the previous lexeme. According to an embodiment of the invention, both the lexical analyzer and the parser are parts of a single program, which may be called a “compiler” and which may perform additional functions, e.g., code generation as described below.

In an embodiment of the invention, the scanner, the parser, or both may be automatically-generated programs, e.g., by certain well-known tools. For example, in an embodiment of the invention, a description of the syntactic elements of the declarative programming language may be used by the lex tool (or its GNU counterpart, known as “flex”) to generate C source code for a scanner suitable for that language. Similarly, for example, a description of the syntax of the declarative programming language, e.g., in Backus-Naur form or one of its variants, may be used by the yacc tool (or its GNU counterpart, known as “bison”) to generate C source code for a parser suitable for that language.

In one embodiment of the invention, lexical analysis in block 470 is performed by a scanner created from source code generated by flex, and parsing in block 472 is performed by a parser created from source code generated by bison to reflect a LALR(1) grammar that specifies a declarative programming language.

Block 474 represents generation of an abstract syntax tree (AST) representing the description in the declarative programming language of the contingent claim. In an embodiment of the invention, the AST may be generated in the course of parsing in block 472, while in another embodiment of the invention, generation of the AST in block 474 may be a distinct step that refers, e.g., to one or more data structures (such as a parse tree) created by the parser. Generation of the AST in block 474 may include, for example, one or more techniques that are well known in the art, such as type checking and pruning any elements of a parse tree that lack semantic content.

In block 476, the AST is further manipulated. For example, according to an embodiment of the invention, the manipulation includes optimization, which may include, e.g., removal of duplicate nodes and/or conversion of data types.

As described above, according to an embodiment of the invention, a declarative programming language may support parameterized descriptions of contingent claims. For example, a description of a type of option according to the language may indicate that the strike price of the option may be specified outside of the description. In connection with such an embodiment, block 476 may include identifying one or more of such parameterized values and/or obtaining one or more such value from an external source, e.g., user input provided at a workstation and/or data acquired from one or more electronic sources such as a DBMS. Any or all parameterized data, e.g., market data, that may be required according to such a description may, in an embodiment of the invention, be acquired in block 456 (FIG. 5) in addition to or instead of acquisition of such parameter-related data in block 476 (FIG. 6).

In an embodiment of the invention such as the one associated with FIG. 3, the AST is used to specify the simulation in block 454 of FIG. 5. According to an embodiment of the invention, specifying the simulation means generating simulation items in the course of traversing the AST, e.g., in postorder. In one such embodiment, the simulation items are the atomic elements used by a simulation engine, e.g., in block 456 of FIG. 5, and the values of the items are, e.g., stored as bytecode for a stack-based virtual machine. Deriving a specification of a simulation from an AST, as in accordance with an embodiment of the invention, may be referred to as “code generation.”

In one exemplary embodiment of the invention, five types of simulation items may be derived from the AST, and, in connection with such an embodiment, those types may be referred to as “spot-processes,” “processes,” “times,” “values,” and “payoffs.” These derived simulation items are, in an embodiment of the invention, the elements of the simulation that is carried out upon execution of the transformed program.

In an embodiment of the invention, a compiler may be configured with information that includes a map between one or more types of nodes and/or subtrees of the AST and one or more types of simulation items. According to an embodiment of the invention, for example, time elements in the declarative programming language are associated directly with respective time simulation items, payoff elements in the programming language are associated directly with respective payoff simulation items, and processes in the programming language are associated directly with respective processes, possibly including spot processes. Some or all such mappings may in an embodiment of the invention be indirect. Some primitives in the declarative programming language according to an embodiment of the invention may be mapped to one or more combinations and/or compositions of simulation items, and some combinations and/or compositions of simulations may be mapped to one or more primitive simulation items.

It will be appreciated, however, that, depending on the embodiment of the invention, some, all, or none of the simulation items may correspond directly and/or indirectly to individual primitives, discussed above, of an exemplary declarative programming language according to an embodiment of the invention, notwithstanding that some simulation items and/or types of simulation items may have the same or similar names as language primitives and/or types of language primitives.

A spot process is a stochastic process that corresponds, e.g., to the prices of a tradable asset or index on a spot market. It may include, among other possibilities, both daily spot prices and intraday spot prices (such as, e.g., intraday maximums, intraday minimums, intraday averages, and intraday “hit” events). In an embodiment of the invention, some or all spot processes may be produced directly by one or more probabilistic models.

A process may be a more general quantity than a spot process. An embodiment of the invention may support multiple stochastic and/or deterministic processes in addition to the spot processes, and any particular process may be, e.g., a constant, a curve, or a quantity derived from spots or other processes by mathematical formula or comparison logic.

One skilled in the relevant arts will appreciate that one way for a declarative programming language to support valuation of a rich variety of contingent claims and other financial instruments is to include sufficient primitive processes and means of composing primitive processes into more complex ones. Although the primitive processes and means of composition will vary depending on the embodiment of the invention, the number of primitive processes may commonly be large enough to support any expected type of contingent claim, but not so large that the declarative programming language becomes unmanageably complex. Thus, in connection with an embodiment of the invention, it may be expected that all but the simplest contingent claims are described in terms of combinations of processes rather than in terms of a single primitive process.

A time is a quantity, e.g., an integer that represents a date in terms of the number of days from a trade date. An embodiment of the invention may include as simulation items one or more of fixed times, hitting times, and times specified in relation to other times. In an embodiment of the invention, a time has one value on each simulation path (described below).

A value according to an embodiment of the invention is a process value at a certain time. It may be used in an embodiment of the invention, e.g., to support formulas that consider process values at a single time or many different times. For example, a value simulation item in a particular simulation may simplify certain simulations if it represents a quantity that would otherwise be represented by a primitive or composite process.

A payoff according to an embodiment of the invention is one or more transactions that take place at one or more times, and may include one or more opportunities for a party to make a choice (or, to put it another way, to exercise an option). Each transaction refers to an action of paying or receiving a certain amount of an asset, e.g., cash. Each time may in an embodiment of the invention be a fixed time or the time at which a triggering event occurs. A payoff according to an embodiment of the invention may also be a combination and/or modification of one or more other payoffs.

In addition to identifying one or more simulation items, traversal of the AST according to an embodiment of the invention may identify one or more parameters that may or must be supplied at execution time. Traversal of the AST in such an embodiment may also identify any dependencies of simulation items upon such parameters.

In an embodiment of the invention, code generation in block 454 is not limited to generating simulation items and/or identifying parameters, but comprises a second traversal of the AST, which may include type-checking and/or optimizations in addition to or instead of those discussed in connection with block 476 of FIG. 6.

According to an embodiment of the invention, simulation items, once generated from an AST, are stored in an ordered list. In such an embodiment, the order is such that items depend only on those elements that appear earlier in the array. For example, in an embodiment of the invention, the first elements are spot processes, followed by other processes, and then times, followed by transactions, and ending with a payoff. Constructing an ordering may in an embodiment of the invention include, e.g., construction of a directed graph indicating dependencies between simulation items. Such an ordering may, e.g., facilitate simulation by allowing a simple linear computation running through the array.

One skilled in the art will recognize that the particular procedures discussed above are among several well-known ways to transform a computer program from a form suited to creation and/or modification (often referred to as “source code”) into a form suited to execution, and that any such technique or combination of techniques may be used in connection with an embodiment of the invention without changing the principle of operation. For example, according to an embodiment of the invention, a program (which may be referred to as an “interpreter”) may execute the source code directly, e.g., by identifying patterns in the source code that correspond to constructs in a programming language.

In another embodiment of the invention, both compilation and interpretation may be used. For example, source code describing a contingent claim may be compiled to an intermediate language, e.g., bytecode, which may in turn be interpreted. For another example, source code may be compiled into another programming language, e.g., a “high-level” language such as C or ECMAScript, a “low-level” language such as assembly language for a particular processor, or any other language, which in turn is executed through one or more stages of compilation and/or interpretation. Execution of any program in any declarative programming language in accordance with embodiments of the invention may involve multiple, alternating and/or consecutive stages of compilation, interpretation, or both.

It will be appreciated that according to an embodiment of the invention, any data and/or data structure (including without limitation, e.g., the source code that expresses the program in a declarative program, any AST generated or modified during compilation, and simulation items and/or instructions that correspond to any one or more simulation items) may be stored temporarily and/or persistently in one or more memories and/or computer-readable storage media comprised by and/or coupled to the computer system. Such stored instructions and/or data may subsequently be read, modified, executed (if appropriate), and/or otherwise processed according to an embodiment of the invention.

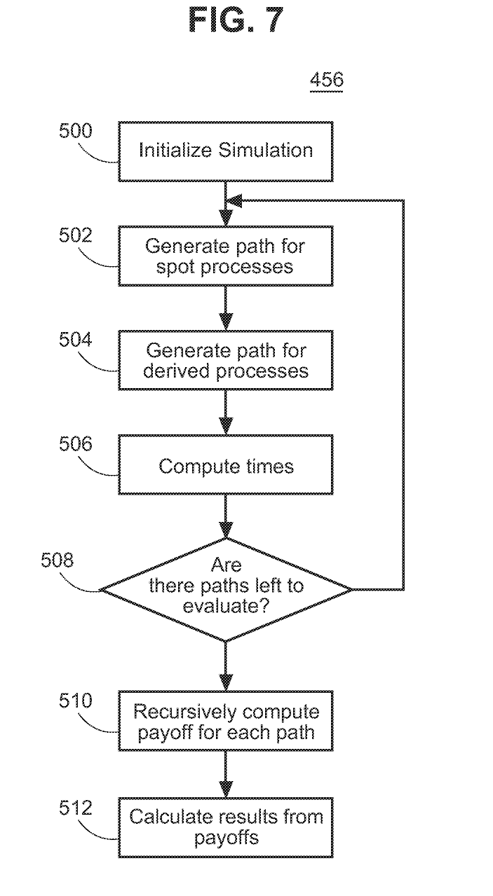

FIG. 7 depicts calculating the value of the contingent claim through simulation, corresponding to block 456 of FIG. 5. It will be appreciated that substantial time, e.g., days, months, or longer, may elapse between code generation in block 454 of FIG. 5 and simulation in block 456. It will further be appreciated that simulation 456 and output of the results in block 458 may occur multiple times following only a single instance of code generation in block 454, and that differing parameters may be supplied for any or all simulation items each time that the simulation is carried out in block 456.

For example, a program such as FIG. 4a depicts describes a generic European-style call giving the holder the right to buy a euro for a specified strike price in dollars. After being compiled a single time, the program may be executed repeatedly. Upon each execution of the program, however, each of the strike price and time to expiration may be the same as or different from any value supplied upon any or all previous executions.

In an embodiment of the invention, simulation, e.g., as depicted in FIG. 7, comprises generation by a Monte Carlo simulation engine of values for each of the simulation items identified during code generation. In an embodiment of the invention in which the simulation items are stored in an ordered list, as discussed above, the simulation engine generates values for the simulation items, e.g., in the order in which the items are stored in the list.

In block 500 of FIG. 7, the simulation engine is initialized. In an embodiment of the invention, initialization comprises, e.g., memory allocation and management and creation and initialization of data structures. Initialization may also include e.g., computation of any specific dates that are relevant to the simulation. As described below, valuation of a contingent claim that includes an opportunity for a party to exercise an option includes in an embodiment of the invention the use of Longstaff-Schwartz methods, and, according to one such embodiment, initialization in block 300 includes selection of state variables for use in such methods.

Blocks 502 through 508 represent generation of paths for processes according to an implementation of the invention. A path represents a series of process values selected, e.g., at the times selected in block 500.

For each path, block 502 represents generation of values for each spot process. In an embodiment of the invention, generating such values may involve generating one or more random and/or pseudo-random numbers and may or may involve calculating one or dependent values based directly or indirectly on one or more of the numbers so generated. Valuation techniques that rely on this generation of random and/or pseudo-random numbers are often referred to as “Monte Carlo methods,” referring to the famous Casino in Monaco.

According to an embodiment of the invention, any of several models may be used to generate a spot path, such as, e.g., the Black-Scholes (Garman-Kohlhagen) model, the Heston model, the mixed local-volatility stochastic-volatility model, and the SABR model, among others. Random or pseudo-random numbers needed by any model may be supplied, e.g., by a pseudo-random number generator such as Mersenne Twister 19937, or by a quasi-random number series, such as a Sobol' sequence or scrambled Sobol' sequence.

In an embodiment of the invention, the model and/or the random or pseudorandom number source may be specified separately from any description of any contingent claim. In such an embodiment, the model and/or number source may be selected, e.g., through one or more environment variables or other methods of supplying parameters to the simulation engine.

In block 504, the paths for any derived processes are generated according to an embodiment of the invention, e.g., based the generated paths for the spot processes.

In an embodiment of the invention, significant times are identified, e.g., from the generated paths, in block 506. In this context, a time may be considered significant if it affects the valuation of the contingent claim. For example, an option may become exercisable once an underlying asset trades at a set price; if a generated spot path for that asset includes that price (or a greater one) on any dates, then the first such date would be considered significant in valuing that claim.

Once it has been determined in block 508 that all specified paths have been evaluated, in an embodiment of the invention asset payoff streams are computed for each path in block 510. In an embodiment of the invention, if the description of the contingent claim uses composition to define a payoff in terms of other payoffs, this computation may be recursive.

In an embodiment of the invention, contingent claims that involve decision making during their existence, such as, e.g., American and Bermudan options, may be deemed to require knowledge of conditional expectations. In such an embodiment, this knowledge may be obtained, e.g., by rolling back the values of the simulation items using a least-squares regression method, such as, e.g., Longstaff-Schwartz Algorithm. According to one embodiment of the invention, the existence of such contingent claims may be signified, e.g., by the appearance of the CHOOSE or PERIODIC_{—}CHOOSE operators in the description of the payoff. In such an embodiment, calculation according to the Longstaff-Schwartz Algorithm may be done in a “bottom-up” fashion that proceeds from the innermost CHOOSE or PERIODIC_{—}CHOOSE operators to the outermost.

In an embodiment of the invention, block 512 represents computation of the sensitivity of the premiums to certain market parameters, possibly including some or all of the Greeks, described above, such as, e.g., market volatility, interest rates, and the price or prices of the underlying asset or assets, among others. According to an embodiment of the invention, the values may be calculated through one or methods, which may include, e.g., well-known methods such as the “Likelihood Ratio Method” and the “Finite Difference Method.”

It will be appreciated that, depending on how some or all simulations are conducted, a simulation that computes a value for a contingent claim, as above, may compute only a single value within a wide distribution of potential values. This value, taken alone, may give little or no information about the present expected value of the claim. According to an embodiment of the invention, such a simulation may therefore be performed repeatedly—e.g., thousands or tens of thousands of time, or even numbers of times that are orders of magnitude greater—and an average of the results may be computed and presented as the expected value of the instrument.

The foregoing discussion, in connection with FIGS. 5-7, is intended only to illustrate one embodiment of the invention, not to limit the invention to the particular process of translating of a description of a contingent claim into a data structure that specifies a simulation and carrying out the specified simulation.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modifications are intended to be included within the scope of the invention. Except to the extent necessary or inherent in the processes themselves, no particular order to steps or stages of methods or processes described in this disclosure, including the Figures, is implied. In many cases the order of process steps may be varied without changing the purpose, effect, or import of the methods described.

We claim:

1. A method of estimating a financial value of a contingent claim, comprising:
storing in at least one computer readable medium coupled to at least one processor a description of the contingent claim in terms of a declarative programming language;
executing on at least one of the processors first instructions to transform the description into second instructions;
executing on at least one of the processors the second instructions to calculate a financial value; and
executing third instructions on at least one of the processors to cause the financial value to be output through an interface coupled to at least one of the processors.

2. The method of claim 1, wherein calculating the financial value comprises using Monte Carlo methods to value at least one asset that is associated with the contingent claim.

3. The method of claim 2, wherein:
the declarative programming language comprises a plurality of primitives;
a first at least one of the primitives signifies a date;
a second at least one of the primitives signifies a calendar;
a third at least one of the primitives signifies an asset;
a fourth at least one of the primitives signifies a time; and
a fifth at least one of the primitives signifies a payoff.

4. The method of claim 3, wherein the declarative programming language requires that the description of the contingent claim comprise at least one of the primitives that signifies an asset, at least one of the primitives that signifies a time, and at least one of the primitives that signifies a payoff.

5. The method of claim 4, wherein transforming the description of the contingent claim comprises:
mapping each of the at least one primitives that signifies an asset to a respective stochastic process;
mapping each of the at least one primitives that signifies a time to a respective stopping time; and
mapping the payoff to a stochastic asset stream.

6. The method of claim 5, wherein the calculated financial value is obtained by applying one or more of the Black-Scholes model, the Heston stochastic volatility model, the mixed local-volatility stochastic-volatility model, and the Longstaff-Schwartz technique to estimate the present financial value of the stochastic asset stream.

7. A system for assigning a value to a contingent claim, comprising:
at least one programmable processor, an interface coupled to the at least one processor through which output may be provided, and at least one memory coupled to the processor;
the at least one memory storing first instructions that, when executed by the processor, cause the system to carry out a method that comprises
transforming a description of the contingent claim, in terms of a declarative programming language, into second instructions;
executing the second instructions to calculate a financial value; and
outputting the financial value through the interface.

8. The system of claim 7, wherein calculating the financial value comprises using Monte Carlo methods to value at least one asset that is associated with the contingent claim.

9. The system of claim 8, wherein:
the declarative programming language comprises a plurality of primitives;
a first at least one of the primitives signifies a date;
a second at least one of the primitives signifies a calendar;
a third at least one of the primitives signifies an asset;
a fourth at least one of the primitives signifies a time; and
a fifth at least one of the primitives signifies a payoff.

10. The system of claim 9, wherein the declarative programming language requires that the description of the contingent claim comprise at least one of the primitives that signifies an asset, at least one of the primitives that signifies a time, and at least one of the primitives that signifies a payoff.

11. The system of claim 10, wherein transforming the description of the contingent claim comprises:
mapping each of the at least one primitives that signifies an asset to a respective stochastic process;
mapping each of the at least one primitives that signifies a time to a respective stopping time; and
mapping the payoff to a stochastic asset stream.

12. The system of claim 11, wherein the calculated financial value is obtained by applying one or more of the Black-Scholes model, the Heston stochastic volatility model, the mixed local-volatility stochastic-volatility model, and the Longstaff-Schwartz technique to estimate the present financial value of the stochastic asset stream.

13. A computer-readable medium encoded with instructions that, when executed by a computer system comprising at least one programmable processor and an interface coupled to at least one of the processors, cause the computer system to carry out a method, comprising:
transforming a description of the contingent claim, in terms of a declarative programming language, into second instructions;
executing the second instructions to calculate a financial value; and
outputting the financial value through the interface.

14. The computer-readable medium of claim 13, wherein calculating the financial value comprises using Monte Carlo methods to value at least one asset that is associated with the contingent claim.

15. The computer-readable medium of claim 14, wherein:
the declarative programming language comprises a plurality of primitives;
a first at least one of the primitives signifies a date;
a second at least one of the primitives signifies a calendar;
a third at least one of the primitives signifies an asset;
a fourth at least one of the primitives signifies a time; and
a fifth at least one of the primitives signifies a payoff.

16. The computer-readable medium of claim 15, wherein the declarative programming language requires that the description of the contingent claim comprise at least one of the primitives that signifies an asset, at least one of the primitives that signifies a time, and at least one of the primitives that signifies a payoff.

17. The computer-readable medium of claim 16, wherein transforming the description of the contingent claim comprises:
mapping each of the at least one primitives that signifies an asset to a respective stochastic process;
mapping each of the at least one primitives that signifies a time to a respective stopping time; and
mapping the payoff to a stochastic asset stream.

18. The computer-readable medium of claim 17, wherein the calculated financial value is obtained by applying one or more of the Black-Scholes model, the Heston stochastic volatility model, the mixed local-volatility stochastic-volatility model, and the Longstaff-Schwartz technique to estimate the present financial value of the stochastic asset stream.

19. A computer-readable medium encoded with a computer program, the computer program comprising:
a description of a contingent claim in terms of a declarative programming language;
wherein the declarative programming language comprises a plurality of primitives;
wherein the description includes at least one primitive that specifies an asset, at least one primitive that specifies a time, and at least one primitive that specifies a payoff; and
wherein the computer program, when executed by a computer, causes the computer to output a financial value for the contingent claim.

20. A method of configuring a computer system, which comprises at least one processor and at least one memory device operatively coupled to the processor, to process data to estimate the financial values of a plurality of types of contingent claims, the method comprising:
storing in at least one of the memory devices first instructions that, when executed by a first at least one of the processors, cause the first at least one of the processors to transform a description of a type of contingent claim into second instructions and to store the second instructions in at least one of the memory devices; and
storing in at least one of the memory devices third instructions that, when executed by a second at least one of the processors, cause a third at least one of the processors to execute the second instructions;
wherein the description of the type of contingent claims is a program in a declarative programming language and the program declares at least one parameter that is to be supplied at a time when the second instructions are executed; and
wherein the second instructions, when executed by the third at least one of the processors, cause the third at least one of the processors to calculate a financial value of a specific contingent claim and to store the financial value in at least one of the memory devices.

21. The method of claim 20, wherein:
the declarative programming language comprises a plurality of primitives;
a first at least one of the primitives signifies a date;
a second at least one of the primitives signifies a calendar;
a third at least one of the primitives signifies an asset;
a fourth at least one of the primitives signifies a time; and
a fifth at least one of the primitives signifies a payoff.

22. The method of claim 21, wherein the declarative programming language requires that the description of the contingent claim comprise at least one of the primitives that signifies an asset, at least one of the primitives that signifies a time, and at least one of the primitives that signifies a payoff.
